(19) United States
(12) Patent Application Publication
(10) Pub. No.: US 2023/0184206 A1
(43) Pub. Date: Jun. 15, 2023

(54) HYDRODYNAMIC TURBINE ROTOR

(71) Applicant: HE-PowerGreen S.r.l., Trento (IT)

(72) Inventors: Lorenzo BATTISTI, Trento (IT); Giuseppe SORAPERRA, Pozza Di Fassa (IT)

(73) Assignee: HE-PowerGreen S.r.l., Trento (IT)

(21) Appl. No.: 17/923,615

(22) PCT Filed: Apr. 30, 2021
(86) PCT No.: PCT/IB2021/053627

§ 371 Date: Nov. 7, 2022

(30) Foreign Application Priority Data
May 5, 2020 (IT) 102020000009916

(51) Int. Cl. F03B 17/06; F03D 3/06

(52) U.S. Cl. CPC F03B 17/063; F03D 3/064; F05B 2230/60; F05B 2240/301; F05B 2240/302; F05B 2240/372; F05B 2260/30

(57) ABSTRACT

A hydrodynamic turbine is described, which comprises: an electric energy generator; a rotor; a rotation shaft having a first end and a second end. Wherein said first end is engaged with said rotor. Said second end of said rotation shaft is coupled to said electric energy generator. Said rotor comprises: a first connection system and a second connection system, each connection system being integrally engaged with said rotation shaft; a first blade module comprising at least two blades, each blade comprising an inner cavity having a substantially rectangular cross-section and being equipped with a first end and a second end. Wherein each connection system comprises a plurality of elongate engagement elements having a substantially rectangular cross-section; each elongate engagement element being coupled to the cavity of a respective blade. Wherein each blade of said first blade module is engaged, at a first end thereof, with said first connection system and, at a second end thereof, with said second connection system.

### FIELD OF THE INVENTION

The present invention relates, in general, to the field of electric energy production. In particular, the present invention relates to a rotor for a hydrodynamic turbine.

### BACKGROUND ART

As is known, energy production from renewable sources is now playing a central role on the international scene. Recently, the European Commission has launched a plan for the so-called “Green Deal”, i.e. a gradual reduction in environmentally harmful emissions until climate neutrality is achieved by 2050.

As is known, one of the most used renewable sources is hydroelectric energy.

Hydroelectric energy is an energy source obtained, for example, by exploiting the water flow of a river and/or an artificial channel, which is suitably conveyed towards a hydrodynamic turbine. Said hydrodynamic turbine transforms the kinetic energy of the water flow into electric energy.

The Applicant has observed that natural and/or artificial watercourses may have, along their path, different sections. In particular, each section may be characterized by different geometries of the wet perimeter and different local speeds of the water flow.

Disadvantageously, such differences among different watercourses and/or among different sections of a single watercourse require a dedicated design phase for each turbine to be installed.

Disadvantageously, each section of a watercourse may require turbines having a different diameter, height and/or number of blades.

The Applicant has noted that designing and manufacturing a specific rotor in order to optimize the production of electric energy and/or the specific cost per kilowatt-hour result in increased production costs.

### SUMMARY OF THE INVENTION

It is the object of the present invention to provide a hydrodynamic turbine rotor that overcomes the above-mentioned problems.

According to a first aspect, the present invention aims at providing a hydrodynamic turbine comprising:
an electric energy generator;
a rotor;
a rotation shaft, said rotation shaft having a first end and a second end, said first end of said rotation shaft being engaged with said rotor; said second end of said rotation shaft being coupled to said electric energy generator;
wherein said rotor comprises:
a first connection system and a second connection system, each connection system being integrally engaged with said rotation shaft;
a first blade module comprising at least two blades, each blade comprising an inner cavity having a substantially rectangular cross-section and being equipped with a first end and a second end;

wherein each connection system comprises a plurality of elongate engagement elements having a substantially rectangular cross-section; each elongate engagement element being coupled to the cavity of a respective blade;
wherein each blade of said first blade module is coupled, at a first end thereof, to said first connection system and, at a second end thereof, to said second connection system.

### BRIEF DESCRIPTION OF THE DRAWINGS

The present invention will become apparent in light of the following detailed description, supplied by way of non-limiting example with reference to the annexed drawings, wherein:

FIGS. 1a and 1b show two illustrative configuration of a hydrodynamic turbine rotor according to the present invention;

FIGS. 2a and 2b show further illustrative configurations of the hydrodynamic turbine rotor according to the present invention;

FIG. 3 shows a blade according to one embodiment of the present invention;

FIGS. 4a and 4b are cross-sectional views along plane H-H of the blade according to some embodiments of the present invention;

FIG. 5 shows a first connection system connecting the blades to a rotation shaft according to one embodiment of the present invention;

FIG. 6 is a sectional view along plane A-A of the first connection system shown in FIG. 4;

FIGS. 7a and 7b show a second connection system connecting the blades to a rotation shaft according to a further embodiment of the present invention;

FIGS. 8a and 8b are sectional views along plane B-B of the second connection system shown in FIG. 7a.

FIG. 9 shows a hydrodynamic turbine according to one embodiment of the present invention;

FIG. 10 shows an electric energy generation system according to the present invention.

The Figures are not in scale.

### DETAILED DESCRIPTION OF SOME EMBODIMENTS

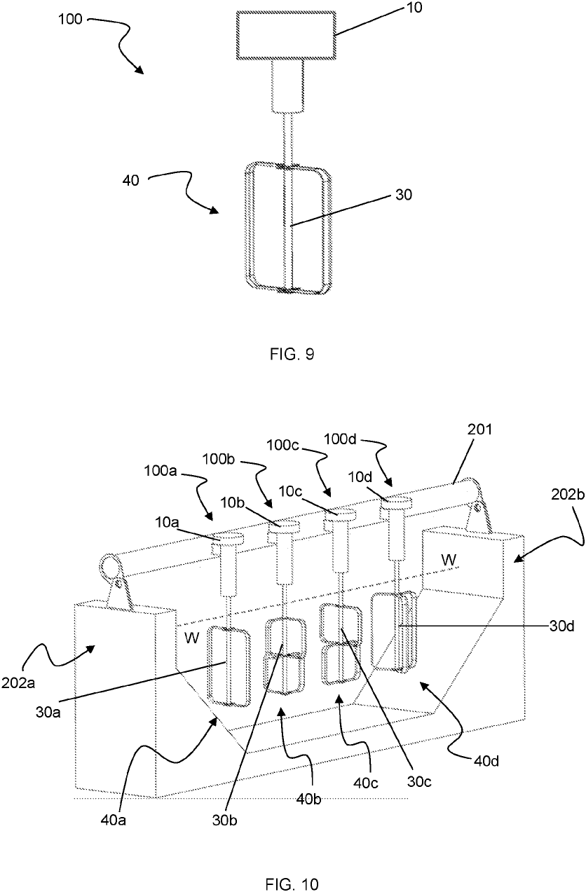

With reference to FIG. 9, the present invention provides a hydrodynamic turbine 100 comprising:
an electric energy generator 10;
a rotor 40;
a rotation shaft 30.

The rotation shaft 30 extends longitudinally and has a first portion and a second portion. In particular, the first portion of the rotation shaft 30 is coupled to the rotor 40; the second portion of the rotation shaft 30 is coupled to the electric energy generator 10.

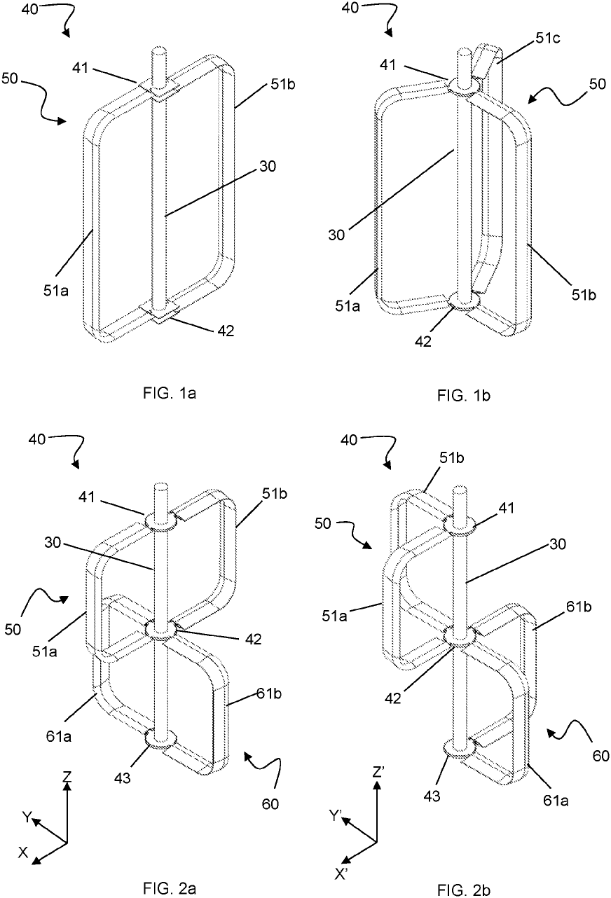

With reference to FIGS. 1a and 1b, the rotor 40 comprises a first connection system 41 and a second connection system 42.

In particular, the first connection system 41 and the second connection system 42 are integrally engaged with the rotation shaft 30.

The rotor 40 comprises a first blade module 50.

In particular, the first blade module 50 comprises at least two blades 51a, 51b. Each blade 51a, 51b of the first blade module 50 is equipped with a first end and a second end.

As will be further described hereinafter, each blade 51a, 51b of the first blade module 50 comprises a respective inner cavity 73 having a substantially rectangular cross-section.

According to the present invention, each connection system 41, 42 comprises a plurality of elongate engagement elements 84, 92.

Each elongate engagement element 84, 92 has a substantially rectangular cross-section.

Preferably, the inner cavity 73 of each blade 51a, 51b of the first blade module 50 has a substantially rectangular cross-section with radiused angles.

Preferably, each elongate engagement element 84, 92 has a substantially rectangular cross-section with radiused angles.

According to the present invention, each elongate engagement element 84, 92 is coupled to the cavity 73 of a respective blade 51a, 51b of the first blade module 50.

In particular, each blade 51a, 51b of the first blade module 50 is coupled, at a first end thereof, to the first connection system 41 and, at a second end thereof, to the second connection system 42.

Preferably, with reference to FIGS. 2a and 2b, the rotor 40 comprises a third connection system 43.

Preferably, the third connection system 43 is integrally engaged with the rotation shaft 30.

Preferably, the rotor 40 comprises a second blade module 60.

Preferably, the second blade module 60 comprises at least two blades 61a, 61b.

In particular, each blade 61a, 61b of the second blade module 60 is equipped with a first end and a second end. Each blade 61a, 61b of the second blade module 60 comprises a respective inner cavity 73 having a substantially rectangular cross-section; preferably, such respective inner cavity 73 has radiused angles.

Preferably, the third connection system 43 comprises a plurality of elongate engagement elements 84, 92 having a substantially rectangular cross-section.

Preferably, such elongate engagement element 84, 92 of the third connection system 43 have a substantially rectangular cross-section with radiused angles.

Preferably, each elongate engagement element 84, 92 of the third connection system is coupled to the cavity 73 of a respective blade 61a, 61b of the second blade module 60.

In particular, each blade 61a, 61b of the second blade module 60 is coupled, at a first end thereof, to the second connection system 42 and, at a second end thereof, to the third connection system 43.

Preferably, the first connection system 41, the second connection system 42 and the third connection system 43 are positioned on the rotation shaft 30 at a predetermined distance.

In other words, the distance between the first connection system 41 and the second connection system 42 is preferably equal to the distance between the second connection system 42 and the third connection system 43 when they are engaged with the rotation shaft 30.

The following will describe some illustrative embodiments of the rotor 40 according to the present invention.

With reference to FIG. 1a, the rotor 40 comprises: the first blade 51a; the second blade 51b; the first connection system 41; and the second connection system 42.

In particular, the first connection system 41 is positioned along the rotation shaft 30; the second connection system 42 is positioned at the free end of the rotation shaft 30.

Preferably, the first blade 51a and the second blade 51b are coupled to the first connection system 41 and to the second connection system 42, and are positioned in such a way as to form an angle of 180° between themselves.

With reference to the illustrative embodiment shown in FIG. 1b, the rotor 40 further comprises a third blade 51c. In particular, the third blade 51c is coupled to the first connection system 41 and to the second connection system 42.

Preferably, the first blade 51a, the second blade 51b and the third blade 51c are coupled to the first and second connection systems 41, 42 in such a way as to form an angle of 120° between two adjacent blades.

In other words, the first blade 51a, the second blade 51b and the third blade 51c are so arranged as to form a mutual angle of 120°.

With reference to the illustrative embodiment shown in FIG. 2a, the rotor 40 comprises:
the first blade module 50 and the second blade module 60;
the first connection system 41, the second connection system 42 and the third connection system 43.

Preferably, the first blade module 50 comprises two blades 51a, 51b; the second blade module 60 comprises two blades 61a, 61b.

Preferably, the two blades 51a, 51b of the first blade module 50 are coupled, at a first end thereof (i.e. the upper end) to the first connection system 41 and, at a second end thereof (i.e. the lower end) to the second connection system 42.

Preferably, the two blades 61a, 61b of the second blade module 60 are coupled, at a first end thereof (i.e. the upper end) to the second connection system 42 and, at a second end thereof (i.e. the lower end) to the third connection system 43.

Preferably, the two blades 51a, 51b of the first blade module 50 and the rotation shaft 30 lie in a first plane X-Z.

Preferably, the two blades 61a, 61b of the second blade module 60 and the rotation shaft 30 lie in a second plane Y-Z.

Even more preferably, the first plane X-Z and the second plane Y-Z are perpendicular to each other.

Preferably, with reference to the illustrative embodiment shown in FIG. 2b, the second blade 51b of the first blade module 50, the first blade 61a of the second blade module 60 and the rotation shaft 30 lie in a third plane Y′-Z′.

Preferably, the first blade 51a of the first blade module 50, the second blade 61b of the second blade module 60 and the rotation shaft 30 lie in a fourth plane X′-Z′.

Even more preferably, the third plane Y′-Z′ and the fourth plane X′-Z′ are perpendicular to each other.

In the following, each blade belonging to the first blade module 50 or to the second blade module 60 will be generally designated by reference numeral 70.

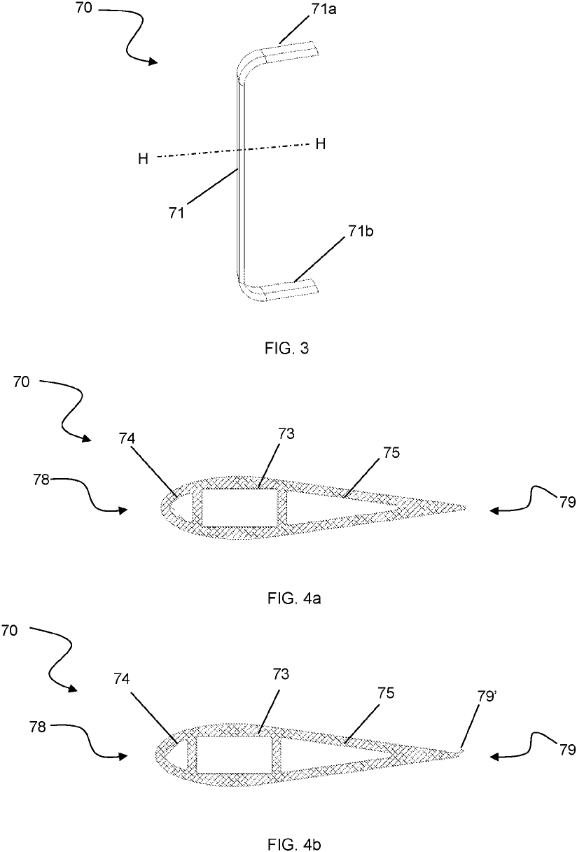

With reference to FIG. 3, each blade 70 of at least one of the first blade module 50 and the second blade module 60 preferably comprises, respectively:
a main tract 71 parallel to said rotation shaft 30; and
two connection tracts 71a, 71b.

It should be noted that the first end of a respective blade 70 corresponds to the free end of the first connection tract 71a; the second end of a respective blade 70 corresponds to the free end of the second connection tract 71b.

Preferably, each connection tract 71a, 71b engages a respective connection system 41, 42, 43.

For example, the main tract 71 has a length of 1 to 4 meters.

For example, the two connection tracts 71a, 71b have a length of 0.7 to 2 meters.

Preferably, such two connection tracts 71a, 71b are arranged transversally, and even more preferably perpendicularly, to the rotation shaft 30.

As aforementioned, with reference to FIG. 4a, each blade 70 of the first blade module 50 and/or of the second blade module 60 is equipped with a respective inner cavity 73 having a substantially rectangular cross-section.

Preferably, each inner cavity 73 has radiused angles.

Preferably, each blade 70 comprises a front cavity 74 and a rear cavity 75. In particular, the front cavity 74 and the rear cavity 75 have a substantially triangular cross-section.

It should be noted that each blade 70 preferably has a hydrodynamic profile and comprises a head portion 78 and a tail portion 79.

Optionally, each blade 70 is equipped with a Gurney flap 79′ at its tail portion 79 (FIG. 4b).

In particular, such Gurney flaps 79′ form an angle of 45° relative to the outer surface of the blade 70.

Preferably, each blade 70 of the first blade module 50 and each blade 70 of the second blade module 60 are substantially equal.

Preferably, each blade 70 of the first blade module 50 and/or of the second blade module 60 is made as one piece.

For example, each blade 70 of the first blade module 50 and/or of the second blade module 60 is made by means of an extrusion process.

In particular, by means of the extrusion process it is possible, after having made a suitable template, to obtain a rod (not shown) with a substantially longitudinal development and internally equipped with a cavity (i.e. the above-described inner cavity 73). Preferably, such rod is also equipped with a cavity with longitudinal development formed in the front part (i.e. the front cavity 74) and a cavity with longitudinal development formed in the rear part (i.e. the rear cavity 75).

Once appropriately bent and cut, such rod forms each blade 70 of the first blade module 50 and/or of the second blade module 60.

Preferably, each blade 70 of the first blade module 50 and/or of the second blade module 60 is made of aluminium. As an alternative, other extrudable alloys may also be considered.

Optionally, the rotor 40 comprises a plurality of safety cords (not shown in the drawing), each safety cord being associated with a respective blade. In particular, each safety cord crosses a cavity 73, 74, 75 of a respective blade 70.

Preferably, each safety cord is engaged, at its ends, with two respective connection systems 41, 42, 43.

For example, with reference to the first connection system 41 and the second connection system 42, and considering a generic blade 70 coupled thereto, the safety cord of the blade 70 is positioned in the inner cavity 73 of the blade 70 and engaged, at a first end thereof, with an elongate engagement element 84, 92 of the first connection system 41 and, at a second end thereof, with an elongate engagement element 84, 92 of the second connection system 42.

Preferably, each safety cord is made of Kevlar or steel.

Advantageously, each safety cord permits retaining the respective blade 70 on the rotation shaft 30, e.g. should a blade 70 break after a collision with a floating body.

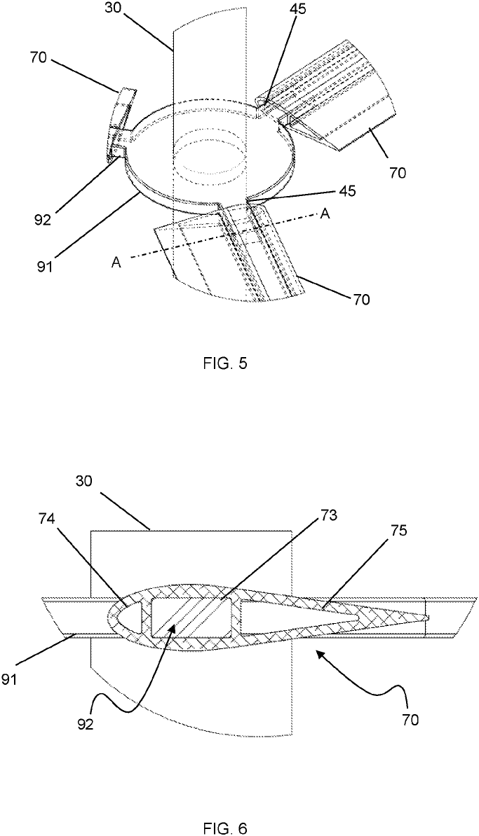

With reference to FIG. 5, according to one embodiment of the present invention at least one of said connection systems 41, 42, 43 comprises a connection flange 91.

Preferably, each elongate engagement element is a protrusion 92. In particular, each protrusion 92 extends in the outward radial direction from said connection flange 91.

Preferably, each protrusion 92 has a substantially rectangular cross-section; even more preferably, said substantially rectangular cross-section has radiused angles.

Preferably, said radial direction is substantially orthogonal to the longitudinal extension of the rotation shaft 30.

Preferably, each protrusion 92 is inserted, at least partly, into the inner cavity 73 at a respective end of a respective blade 70.

Preferably, each connection flange 91 is integrally engaged with the rotation shaft 30. In particular, each connection flange 91 is fitted onto the rotation shaft 30.

As shown in FIG. 5, each connection flange 91 comprises at least two protrusions 92.

Preferably, each end of a respective blade 70 of the first blade module 50 and/or of the second blade module 60 is coupled to a respective protrusion 92 by means of a glue. For example, such glue may be applied onto the protrusions 92 of each connection flange 91.

According to a variant of the present invention, at least one of said connection systems 41, 42, 43 comprises a sandwich structure 80.

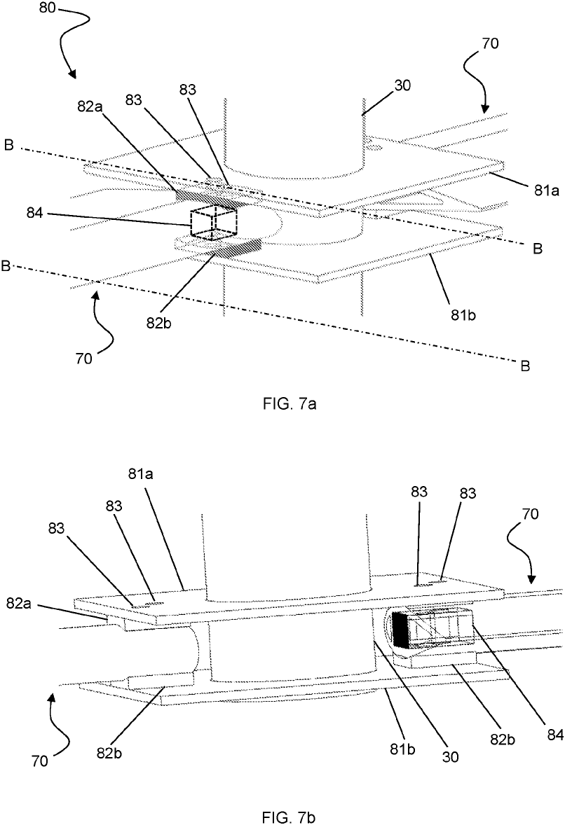

With reference to FIGS. 7a and 7b, each sandwich structure 80 comprises:
a pair of tightening plates 81a, 81b fitted onto the rotation shaft 30; and
a pair of coupling shims 82a, 82b.

Preferably, each elongate engagement element is a rectangular shim 84.

Preferably, such rectangular shim 84 is inserted into the inner cavity 73 at a respective end of a respective blade 70.

Preferably, said end of a respective blade 70 and said rectangular shim 84 are interposed between the pair of coupling shims 82a, 82b and the pair of tightening plates 81a, 81b, as will be described in detail below.

Preferably, each tightening plate 81a, 81b is made of steel.

Preferably, each coupling shim 82a, 82b has a first surface and a second surface, opposite to said first surface. In particular, said first surface is substantially flat and said second surface is substantially concave.

Preferably, each coupling shim 82a, 82b is made of aluminium.

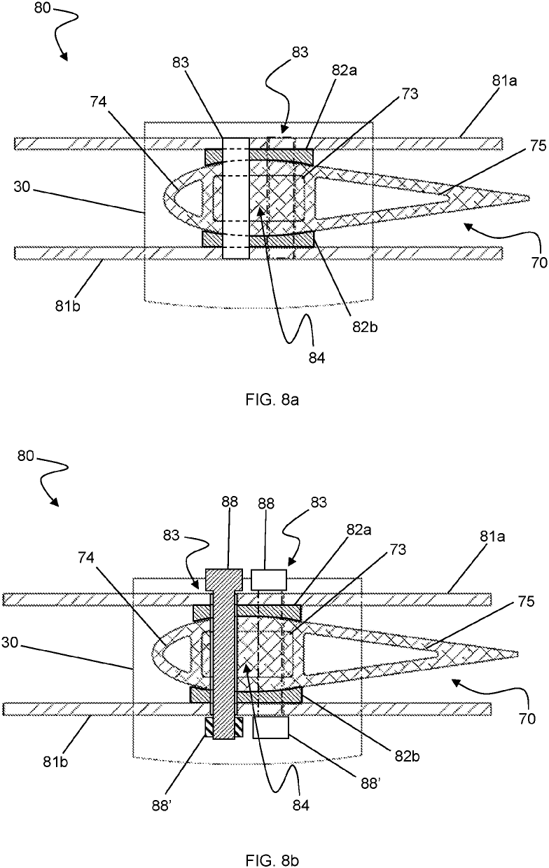

With reference to FIGS. 8a and 8b, the sandwich structure 80 preferably comprises at least two tightening screws 88 and at least two tightening seats 83.

Preferably, each tightening screw 88 is inserted into a suitable tightening seat 83 and locked, for example, by means of a respective nut 88′.

Preferably, each tightening seat 83 crosses, from top to bottom, the first tightening plate 82a, the first coupling shim 82a, a respective blade 70, the rectangular shim 84, the second coupling shim 82b and the second tightening plate 82b.

In other words, each first tightening plate 82a, each first coupling shim 82a, each rectangular shim 84, each second coupling shim 82b and each second tightening plate 82b of a sandwich structure 80 are equipped with at least two through holes. Moreover, each blade 70 engaged with a sandwich structure 80 has at least two through holes at the end thereof which is to be engaged with said sandwich structure 80. Such holes form the at least two tightening seats 83.

Preferably, each tightening seat 83 is parallel to the rotation shaft 30.

Preferably, at least two of such tightening seats 83 are arranged at different distances from the rotation shaft 30.

With reference to FIG. 8a, it should be noted that:
the first tightening plate 81a is coupled to the first surface (i.e. the substantially flat surface) of the first coupling shim 82a;
the second surface (i.e. the substantially concave surface) of the first coupling shim 82a is coupled to a first side of the blade 70;
the second surface (i.e. the substantially concave surface) of the second coupling shim 82b is coupled to a second side of the blade 70, opposite to the first side;
the second tightening plate 81b is coupled to the first surface (i.e. the substantially flat surface) of the second coupling shim 82b.

In other words, the concave surface of each coupling shim 82a, 82b faces towards a respective blade 70.

According to the present invention, as shown in FIG. 10, an electric energy generation system 200 is provided.

The electric energy generation system 200 comprises:
a plurality of hydrodynamic turbines 100a, 100b, 100c, 100d as described above;
a crossbar 201, having a first end and a second end.

Such plurality of hydrodynamic turbines 100a, 100b, 100c, 100d are engaged with the crossbar 201. In particular, the plurality of hydrodynamic turbines 100a, 100b, 100c, 100d are engaged with the crossbar 201 and are arranged in such a way that the rotation shafts 30a, 30b, 30c, 30b of said hydrodynamic turbines 100a, 100b, 100c, 100d are substantially parallel to one another.

Preferably, each rotation shaft 30a, 30b, 30c, 30b is orthogonal to the crossbar 201.

Preferably, the rotors 40a, 40b, 40c, 40d are all equal; FIG. 10 shows different rotors for the sole purpose of illustrating different options.

According to a further aspect of the present invention, a method for generating electric energy is provided.

Preferably, the method according to the invention comprises the following steps:
providing the electric energy generation system 200;
fixing the first and second ends of the crossbar 201 on opposite sides 202a, 202b of an artificial water channel 202, so that at least the rotors 40a, 40b, 40c, 40d of each hydrodynamic turbine 100a, 100b, 100c, 100d are submerged in water.

Preferably, the electric energy generators 10a, 10b, 10c, 10d of each hydrodynamic turbine 100a, 100b, 100c, 100d are located above the water level W.

Preferably, the crossbar 201 is substantially orthogonal to the direction of the water flow.

As aforementioned, the rotors 40a, 40b, 40c, 40d of each hydrodynamic turbine 100a, 100b, 100c, 100d are partially submerged in water. Such rotors 40a, 40b, 40c, 40d are made to rotate, by the forces exerted on the respective blades 70 by the water flow, about the longitudinal axis of the respective rotation shaft 30a, 30b, 30c, 30b. By turning they produce, in co-operation with the respective electric energy generator 10a, 10b, 10c, 10d, electric energy.

The generation of electric energy by means of a hydrodynamic turbine is known and will not be described in detail herein.

The present invention offers important advantages.

In particular, it is advantageously possible to make rotors having blades 70 of different length (i.e. the sum of the length of the main tract 71 and the length of the connection tracts 71a, 71b) without having to modify the blade production process.

In fact, advantageously, the blades can be created by varying the length of the main tract 71 and/or of each connection tract 71a, 71b by simply changing the bending of the rod made, for example, by extrusion.

Such bending is advantageously facilitated by the presence of the inner cavity 73, which also permits coupling each blade 70 to two respective connection systems 41, 42, 43, as previously described.

As described above, said substantially rectangular inner cavity 73 makes it possible to couple each blade 70 to a rotation shaft 30 by means of:
the connection flange 91; or
the sandwich structure 80.

Advantageously, such connection systems permit reducing the fatigue deterioration of the rotor 40.

1. A hydrodynamic turbine comprising:
an electric energy generator;
a rotor;
a rotation shaft, said rotation shaft having a first end and a second end;
said first end of said rotation shaft being engaged with said rotor;
said second end of said rotation shaft being coupled to said electric energy generator;
wherein said rotor comprises:
a first connection system and a second connection system, each connection system being integrally engaged with said rotation shaft;
a first blade module comprising at least two blades, each blade comprising an inner cavity having a substantially rectangular cross-section and being equipped with a first end and a second end;
wherein each connection system comprises a plurality of elongate engagement elements having a substantially rectangular cross-section; each elongate engagement element being coupled to the cavity (73) of a respective blade;
wherein each blade of said first blade module is coupled, at a first end thereof, to said first connection system and, at a second end thereof, to said second connection system.

2. The hydrodynamic turbine according to claim 1, wherein said rotor comprises:
a third connection system (43), said third connection system being integrally engaged with said rotation shaft;
a second blade module comprising at least two blades, each blade of said second blade module comprising an inner cavity having a substantially rectangular cross-section and being equipped with a first end and a second end;
wherein said third connection system comprises a plurality of elongate engagement elements,having a substantially rectangular cross-section; each elongate engagement element being coupled to said cavity of a respective blade of said second blade module;
wherein each blade of said second blade module is coupled, at a first end thereof, to said second connection system and, at a second end thereof, to said third connection system.

3. The hydrodynamic turbine according to claim 1, wherein at least one of said connection systems comprises a connection flange and each elongate engagement element is a protrusion extending in the outward radial direction from said connection flange;
wherein each protrusion is inserted, at least partly, into said inner cavity at a respective end of a respective blade .

4. The hydrodynamic turbine according to claim 1, wherein at least one of said connection systems comprises a sandwich structure; said sandwich structure comprising:
a pair of tightening plates fitted onto said rotation shaft;
a pair of coupling shims;
wherein each elongate engagement element is a rectangular shim;
wherein said rectangular shim is inserted into said inner cavity at a respective end of a respective blade;
wherein said end of a respective blade and said rectangular shim (84) are interposed between said pair of coupling shims and said pair of tightening plates .

5. The hydrodynamic turbine according to claim 1, wherein each blade of at least one of said first blade module and said second blade module comprises, respectively:
a first tract parallel to said rotation shaft;
two connection tracts, which engage a respective connection system ;
wherein said two connection tracts are arranged transversally, preferably perpendicularly, to said rotation shaft.

6. The hydrodynamic turbine according to claim 2, wherein said first blade module comprises two blades and said second blade module comprises two blades;
wherein said two blades of said first blade module and said rotation shaft lie in a first plane (X-Z);
wherein said two blades of said second blade module and said rotation shaft lie in a second plane (Y-Z);
wherein said first plane (X-Z) and said second plane (Y-Z) are perpendicular to each other.

7. The hydrodynamic turbine according to claim 2, wherein said first blade module comprises a first blade and a second blade;
said second blade module comprises a first blade and a second blade;
wherein said second blade of said first blade module, said first blade of said second blade module and said rotation shaft lie in a third plane (Y′-Z′);
wherein said first blade of said first blade module , said second blade of said second blade module and said rotation shaft lie in a fourth plane (X′-Z′);
wherein said third plane (Y′-Z′) and said fourth plane (X′-Z′) are perpendicular to each other.

8. The hydrodynamic turbine according to claim 1, wherein each blade is made of aluminium.

9. The hydrodynamic turbine according to claim 1, wherein each blade has a hydrodynamic profile and comprises a head portion and a tail portion ,said tail portion comprising a Gurney flap.

10. An electric energy generation system comprising:
a plurality of hydrodynamic turbines according to claim 1;
a crossbar;
wherein said plurality of hydrodynamic turbines are engaged with said crossbar and arranged in such a way that the rotation shafts of said plurality of hydrodynamic turbines are substantially parallel to one another.

11. A method for generating electric energy, comprising:
providing an electric energy generation system according to claim 10, said crossbar having a first end and a second end;
fixing said first and second ends of said crossbar on opposite sides of an artificial water channel, so that the rotors of each hydrodynamic turbine are submerged in water.
